(19) United States
(12) Patent Application Publication
(10) Pub. No.: US 2012/0231102 A1
(43) Pub. Date: Sep. 13, 2012

(54) DEVICE FOR GRANULATING

(75) Inventor: Stefan Dahlheimer, Kleinostheim (DE)

(73) Assignee: AUTOMATIK PLASTICS MACHINERY GMBH, Grossostheim (DE)

(21) Appl. No.: 13/475,791

(22) Filed: May 18, 2012

(30) Foreign Application Priority Data
Nov. 20, 2010 (EP) PCT/EP2010/007017

(51) Int. Cl. B29C 47/90

(52) U.S. Cl. 425/67

(57) ABSTRACT

A device for granulating melt emerging from nozzles can have a perforated plate. A cutter arrangement with at least one cutter can be driven by a motor opposite the perforated plate, such that the at least one cutter passes over the nozzles in the perforated plate to sever pellets of the emerging melt material. The device can include a housing that connects to the perforated plate and surrounds at least one cutter. A coolant can flow through the housing. The device can include an inlet disposed in a lower half of the housing. The inlet can have an inlet opening connected to an inlet channel for allowing coolant to flow into the housing and an outlet can be in fluid communication with the housing.

### CROSS REFERENCE TO RELATED APPLICATIONS

The present application claims priority to and the benefit of co-pending International Patent Application No. PCT/EP2010/007017, filed on Nov. 20, 2010, entitled “DEVICE FOR GRANULATING”. This reference is hereby incorporated in its entirety.

### FIELD

The present embodiments generally relate to a device for granulating melt.

### BACKGROUND

A need exists for a device for granulating melt.

A further need exists for a device for granulating melt that provides guidance of coolant without excessive turbulence.

A further need exists for a device for granulating melt that provides guidance of coolant with pellets contained therein after granulation has occurred for carrying away the pellets to reduce clumping caused by the pellets sticking together.

The present embodiments meet these needs.

### BRIEF DESCRIPTION OF THE DRAWINGS

The detailed description will be better understood in conjunction with the accompanying drawings as follows:

FIG. 1 depicts a schematic top view of the device according to one or more embodiments.

FIG. 2 depicts another schematic top view of the device according to one or more embodiments.

FIG. 3 depicts a schematic cross-sectional view of the device of FIG. 1 depicted along section A-A in FIG. 1.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

The present embodiments relate to a device for granulating material emerging from nozzles in a perforated plate that allows for efficient granulation, while simultaneously allowing for reliable and fast transport of pellets produced with the device.

A cutter arrangement with at least one cutter can be disposed opposite the perforated plate. The at least one cutter can be driven by a motor. As such, the at least one cutter can pass over the nozzles in the perforated plate to sever the pellets of a melt material emerging from the nozzles.

A housing can be connected to the perforated plate. The housing can surround at least the at least one cutter.

The housing can have an inlet for receiving a coolant and an outlet for expelling the coolant and the pellets. As such, the coolant can flow through the housing.

The inlet can be located in a lower half of the housing. The inlet can have an inlet opening in the housing and an inlet channel arranged to lead to the housing. The inlet channel can be arranged to extend in a straight line or essentially in a straight line path. In embodiments in which the inlet channel is arranged to extend in essentially a straight line path, the inlet channel can have curves or bends therein.

The outlet can be located in an upper half of the housing. The outlet can have an outlet opening in the housing and an outlet channel arranged to lead tangentially away from the housing. The outlet channel can extend in a straight line or essentially in a straight line path over a length that is at least twice a largest inside diameter of a cross-section of the housing. In embodiments in which the outlet channel is arranged to extend in essentially a straight line path, the outlet channel can have curves or bends therein.

The inlet and the outlet can allow for efficient granulation, while simultaneously allowing for reliable and fast transport of the pellets present in the coolant.

The outlet channel leading tangentially away from the housing can prevent significant constriction of a flow of the coolant with the pellets therein, and thus an outlet cross-section can lack significant narrowing. Consequently, as the pellets in the coolant can be expelled from the housing without being forced together at a wall of the outlet. The arrangement of the outlet channel and the outlet opening can reduce the risk of contact between the pellets being expelled from the outlet, thereby reducing the possibility that the pellets will stick together.

The inlet opening and the inlet channel can provide an improved, trouble-free inflow of the coolant into the housing, thereby making flow conditions in the housing more uniform and controllable.

Efficient granulation can be provided by improved, defined flow conditions, in which a dwell time of the pellets in the housing can be more uniform. The uniform dwell time of the pellets in the housing can improve uniformity and quality of the pellets produced by the device. A statistical Gaussian distribution of the dwell times of the pellets can be made narrower by the flow conditions that are defined by the inlet channel and inlet opening.

The design of the device can also reduce dead zones, in which either no flow or only slight flow of the coolant occurs, and thus in which the risk of clumping of the pellets present in the coolant is higher.

The inlet channel can be arranged to lead tangentially to the housing. The inlet channel can provide a directed flow in the housing, with a rotating eddy of the coolant being produced immediately when the coolant enters the housing. Any air still present in the housing can be easily conveyed out of the housing by the rotating eddy, such as during a startup process of the device.

During operation of the device an appropriately directed flow in the housing can further reduce the risk of the pellets in the coolant sticking together.

The outlet on the housing can be arranged in a front region of the housing in an area of motion of the at least one cutter near the perforated plate.

The inlet on the housing can be arranged in a rear region of the housing when viewed in a longitudinal direction, and can be in a region facing away from the perforated plate.

The flow of the coolant that results in an eddy flow from the rear region to the front region can be uniform and free of harmful additional turbulence in the housing. Consequently, the pellets produced in the front region of the housing can be discharged in the coolant quickly through the outlet without significant back flow to the rear region of the housing, which could otherwise lead to clumping of the pellets in the coolant.

The inlet and the outlet can be located on a same side when viewed in a cross-section of the housing. Consequently, the eddy flow can develop without significant additional deflection of the flow from the inlet to the outlet.

The outlet channel can have, in a region of the straight line or essentially straight line path, a curve with a degree of curvature of less than 30 degrees. The curve can be less than 15 degrees when measured between a center axis of an initial region of the straight line or essentially straight line path of the outlet channel, and a center axis of an end region of the straight line or essentially straight line path of the outlet channel.

The outlet channel can prevent the pellets from sticking together in the coolant, without changes or with only slight changes in a direction of flow of the coolant with the pellets present therein in the outlet channel.

The outlet channel can have a constant cross-section over a length of the straight line or essentially straight line path; thereby reducing occurrence of the pellets sticking together.

The outlet channel can have one or more changes in cross-section over the length of the straight line or essentially straight line path, such as widening or narrowing of the cross-section. Each widening or narrowing of the cross-section over a length of the changes in cross-section can have a generating angle of less than 15 degrees relative to a center axis of the outlet channel. As such, the device can provide flexible adjustment to specific materials to be granulated, for example, with regard to a throughput or flow rate of the coolant, while keeping the risk of clumping of the pellets caused by sticking together in the coolant as low as possible.

Depending on the material to be granulated, the length of the straight line or essentially straight line path of the outlet channel can be at least ten times a local diameter of the outlet channel at a particular spot. As a result, an adequately long cooling section free of narrowing or essentially free of narrowing can be provided in the outlet channel for the pellets present in the coolant. The adequately long cooling section free of narrowing or essentially free of narrowing can have no obstructions to the flow therein, which otherwise could lead to the risk of clumping of the pellets undergoing cooling in the coolant therein.

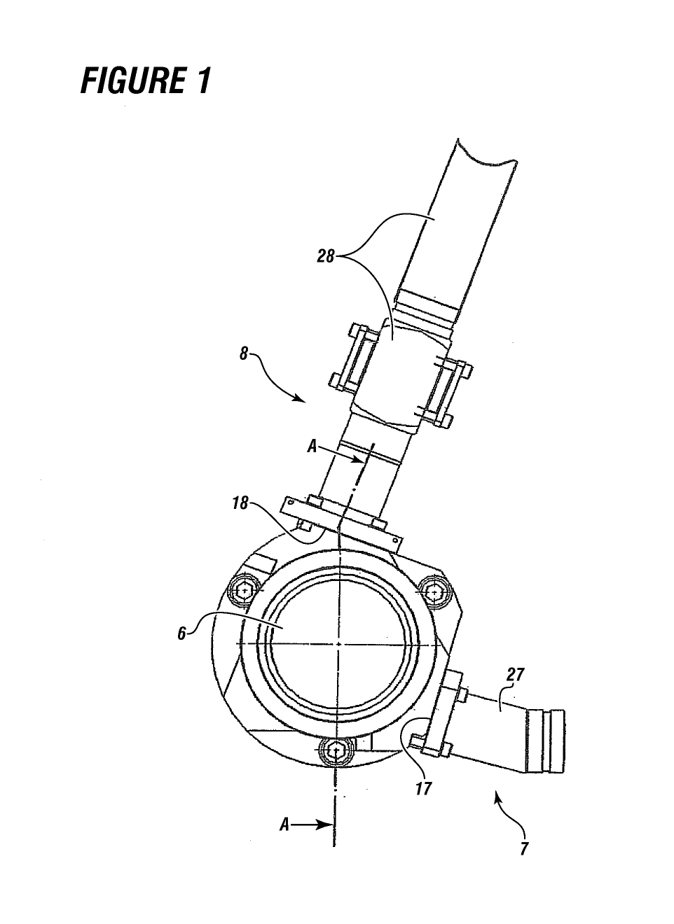

Turning now to the Figures, FIG. 1 depicts a schematic top view of a device for granulating thermoplastic material emerging from nozzles in a die plate according to one or more embodiments.

The housing 6 can have an inlet 7. The inlet 7 can provide coolant fluid to the housing 6. The coolant fluid can flow through the housing 6 and out of the outlet 8. As the coolant fluid is expelled from the housing 6 via the outlet 8, the coolant fluid can contain the pellets.

The inlet 7 can be located in the lower half of the housing 6. For example, the inlet 7 can be located at a position between a four o'clock position and a five o'clock position.

The inlet 7 can have an inlet opening 17 in the housing 6 and an inlet channel 27 arranged to lead to the housing 6. The inlet channel 27 can be arranged to lead in a straight line and tangentially to the housing 6.

The outlet 8 can be located in the upper half of the housing 6. For example, the outlet 8 can be at a position between a ten o'clock position and a two o'clock position.

The outlet 8 can have an outlet opening 18 in the housing 6 and an outlet channel 28 arranged to lead tangentially away from the housing 6.

The outlet channel 28 can extend in a straight line over a length of at least twice the largest inside diameter of the cross-section of the housing 6. Furthermore, the length of the straight line path of the outlet channel 28 can be at least ten times the local diameter of the outlet channel at a corresponding location of the outlet channel. In one or more embodiments, the length of the outlet channel 28 can extend beyond the length shown in FIG. 1.

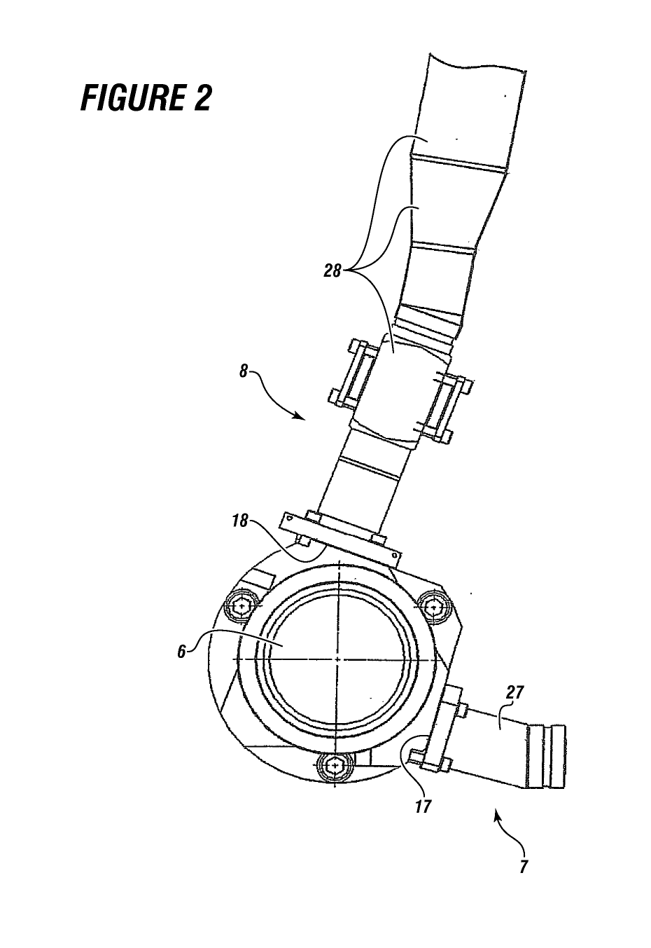

FIG. 2 depicts a schematic top view of the device for granulating according to one or more embodiments.

The outlet channel 28 extend in a essentially straight line and can have a region of the essentially straight-line path. The outlet channel 28 can have a curve with a degree of curvature of approximately 10 degrees measured between a center axis of the initial region of the straight line or essentially straight line path of the outlet channel 28, such as in the region near the outlet opening 18, and a center axis of the end region of the essentially straight-line path of the outlet channel 28 in the top region.

The outlet channel 28 can have, for example, one change in cross-section over the length of its essentially straight-line path, namely a widening of the cross-section, such that the generating angle of the outlet channel 28 is approximately 10 degrees over the length of the change in cross-section relative to the center axis of the outlet channel 28 at that point.

The inlet 7 can have the inlet opening 17 and the inlet channel 27.

The inlet 7 and the outlet 8, when viewed in cross-section of the housing 6, can be disposed on the same side of an axis of symmetry of the housing 6 that extends diagonally in a plane of FIG. 2. As such, the inlet 7 and the outlet 8 are not disposed with radial symmetry about the axis of symmetry projecting out of the plane of FIG. 2 in a center of the housing 6 with a circular cross-section, but are disposed on the same side of a flow direction of an eddy flow in the housing 6 or a corresponding outflow direction at the outlet 8.

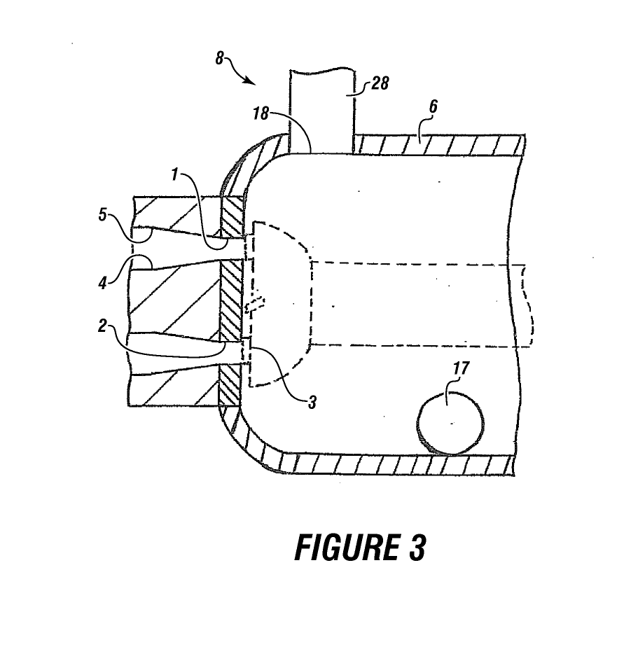

FIG. 3 depicts a schematic cross-sectional view of the device of FIG. 1 depicted along the section A-A in FIG. 1.

The device can granulate melt material emerging from nozzles 1 in a perforated plate 2.

The melt material, for example a thermoplastic material, can be supplied to the nozzles 1 through a melt distribution element 4 with melt channels 5 disposed therein.

A cutter arrangement with at least one cutter 3 can be disposed opposite the perforated plate 2, and can be driven by a motor.

The at least one cutter 3 can pass over the nozzles 1 in the perforated plate 2; thereby severing pellets of the emerging melt material in the production process.

The housing 6 can connect to the perforated plate 2, and can surround at least the at least one cutter 3 of the cutter arrangement.

The coolant fluid can flow into the housing 6 via the inlet opening 17, and the coolant and entrained pellets can flow out of the housing 6 via the outlet 8.

The inlet can be disposed in the lower half of the housing 6 with the inlet opening 17 disposed in the housing 6. The inlet on the housing 6 can be disposed, when viewed in the longitudinal direction of the housing 6, in a rear region of the housing 6 and in a region facing away from the perforated plate 2.

The outlet 8 can be disposed in the upper half of the housing 6 and can have the outlet opening 18 in the housing 6, as well as the outlet channel 28 leading tangentially away from the housing 6.

The outlet channel 28 can extend in a straight line or essentially in a straight line over the length that is at least twice the largest inside diameter of the cross-section of the housing 6.

The outlet 8 can be disposed on the housing 6 in a front region of the housing 6, when viewed in the longitudinal direction of the housing 6, and in the area of motion of the at least one cutter 3 near the perforated plate 2.

While these embodiments have been described with emphasis on the embodiments, it should be understood that within the scope of the appended claims, the embodiments might be practiced other than as specifically described herein.

What is claimed is:

1. A device for granulating melt emerging from nozzles, the device comprising:
a. a perforated plate comprising the nozzles;
b. a cutter arrangement with at least one cutter driven by a motor opposite the perforated plate, wherein the at least one cutter passes over the nozzles in the perforated plate for severing pellets of a melt material emerging from the nozzles;
c. a housing connected to the perforated plate and surrounding at least the at least one cutter, wherein a coolant flows through the housing;
d. an inlet disposed only in a lower half of the housing, wherein the inlet comprises an inlet opening connected to an inlet channel for allowing the coolant to flow into the housing; and
e. an outlet in fluid communication with the housing, wherein the outlet comprises an outlet opening located in an upper half of the housing and an outlet channel in fluid communication with the outlet opening, wherein the outlet channel is arranged to lead tangentially away from the housing, and wherein the outlet channel extends in a straight line or essentially straight line path over a length that is at least twice a largest inside diameter of a cross-section of the housing.

2. The device of claim 1, wherein the inlet and the outlet are disposed on a same side of the housing.

3. The device of claim 1, wherein the outlet channel has, in a region of the straight line or essentially straight line path, a curve with a degree of curvature of less than 30 degrees measured between:
a. a center axis of an initial region of the straight line or essentially straight line path of the outlet channel; and
b. a center axis of an end region of the straight line or essentially straight line path of the outlet channel.

4. The device of claim 1, wherein the outlet channel has a constant cross-section over a length of the straight line or essentially straight line path.

5. The device of claim 1, wherein the outlet channel has one or more changes in cross-section over a length of the straight line or essentially straight line path, and wherein each widening or narrowing of the cross-section over a length of the changes in cross-section has a generating angle of less than 15 degrees relative to a center axis of the outlet channel.

6. The device of claim 1, wherein a length of the straight line or essentially straight line path of the outlet channel is at least ten times a local diameter of the outlet channel.

7. The device of claim 1, wherein the inlet channel is arranged to lead tangentially to the housing.

8. The device of claim 7, wherein the inlet and the outlet are disposed on a same side of the housing.

9. The device of claim 7, wherein the outlet channel has, in a region of the straight line or essentially straight line path, a curve with a degree of curvature of less than 30 degrees measured between:
a. a center axis of an initial region of the straight line or essentially straight line path of the outlet channel; and
b. a center axis of an end region of the straight line or essentially straight line path of the outlet channel.

10. The device of claim 9, wherein the outlet channel has a constant cross-section over a length of the straight line or essentially straight line path.

11. The device of claim 9, wherein the outlet channel has one or more changes in cross-section over a length of the straight line or essentially straight line path, and wherein each widening or narrowing of the cross-section over a length of the changes in cross-section has a generating angle of less than 15 degrees relative to a center axis of the outlet channel.

12. The device of claim 9, wherein a length of the straight line or essentially straight line path of the outlet channel is at least ten times a local diameter of the outlet channel.

13. The device of claim 9, wherein the outlet is disposed in a front region of the housing in an area of motion of the at least one cutter near the perforated plate, and wherein the inlet is disposed in a rear region of the housing and in a region facing away from the perforated plate.

14. The device of claim 13, wherein the outlet channel has, in a region of the straight line or essentially straight line path, a curve with a degree of curvature of less than 30 degrees measured between:
a. a center axis of an initial region of the straight line or essentially straight line path of the outlet channel; and
b. a center axis of an end region of the straight line or essentially straight line path of the outlet channel.

15. The device of claim 13, wherein the outlet channel has a constant cross-section over a length of the straight line or essentially straight line path.

16. The device of claim 1, wherein the outlet is disposed in a front region of the housing in an area of motion of the at least one cutter near the perforated plate, and wherein the inlet is disposed in a rear region of the housing and in a region facing away from the perforated plate.

17. The device of claim 16, wherein the inlet and the outlet are disposed on a same side of the housing.

18. The device of claim 16, wherein the outlet channel has, in a region of the straight line or essentially straight line path, a curve with a degree of curvature of less than 30 degrees measured between:
a. a center axis of an initial region of the straight line or essentially straight line path of the outlet channel; and
b. a center axis of an end region of the straight line or essentially straight line path of the outlet channel.

19. The device of claim 16, wherein the outlet channel has a constant cross-section over a length of the straight line or essentially straight line path.

20. The device of claim 16, wherein the outlet channel has one or more changes in cross-section over a length of the straight line or essentially straight line path, and wherein each widening or narrowing of the cross-section over a length of the changes in cross-section has a generating angle of less than 15 degrees relative to a center axis of the outlet channel.
